(19) United States
(12) Patent Application Publication
(10) Pub. No.: US 2025/0385429 A1
(43) Pub. Date: Dec. 18, 2025

(54) PLANAR ANTENNA AND ANTENNA DEVICE

(71) Applicant: NEC Corporation, Tokyo (JP)

(72) Inventors: Kohei YOSHIDA, Tokyo (JP); Fujio Okumura, Kanagawa (JP)

(73) Assignee: NEC Corporation, Tokyo (JP)

(21) Appl. No.: 19/185,371

(22) Filed: Apr. 22, 2025

(30) Foreign Application Priority Data
Jun. 13, 2024 (JP) 2024-095916

(51) Int. Cl. H01Q 9/04; H01Q 1/00; H01Q 1/48; H01Q 3/36

(52) U.S. Cl. CPC H01Q 9/0407; H01Q 1/002; H01Q 1/48; H01Q 3/36

(57) ABSTRACT

A planar antenna including an antenna substrate on which at least one patch antenna, a signal line connected to the patch antenna, and a metal-insulator phase transition element provided on the signal line are arranged, and a temperature control substrate including a thin film transistor circuit and in which at least one heat generating element whose temperature is controlled by the thin film transistor circuit is disposed, wherein the antenna substrate and the temperature control substrate are laminated such that heat of the heat generating element can be conducted to the metal-insulator phase transition element.

This application is based upon and claims the benefit of priority from Japanese Patent Application No. 2024-095916, filed on Jun. 13, 2024, the disclosure of which is incorporated herein in its entirety by reference.

### TECHNICAL FIELD

The present disclosure relates to a planar antenna and an antenna device.

### BACKGROUND ART

Phase transition elements utilizing metal-insulator phase transition have been developed. PTL 1 (JP 2017-504283 A) discloses a switch using a phase transition element. The phase transition element of PTL 1 has metal characteristics only in a predetermined temperature range. PTL 1 discloses an example using a vanadium dioxide thin film.

By using a phase transition element using a metal-insulator phase transition as a switch, a phase shifter that can be selected by temperature controlling the phase transition element can be achieved. A phased array antenna can be configured by arranging such phase shifters in an array shape in association with a patch antenna. For example, a phased array antenna capable of transmitting a radio wave in a desired direction can be achieved by temperature controlling a plurality of phase transition elements individually using a thin film transistor circuit (TFT circuit) including a thin film transistor (TFT) as a drive circuit.

By using the vanadium dioxide thin film as the phase transition element, an additional high temperature is applied after the manufacturing process of the TFT circuit is finished in order to form a phase transition element including a vanadium dioxide layer that undergoes metal-insulator phase transition. When an additional high temperature is applied, the TFT circuit has a possibility of being damaged. Therefore, in a general manufacturing method, it has been difficult to achieve an antenna device mounted with a vanadium dioxide thin film that can be temperature controlled by the TFT circuit.

An object of the present disclosure is to provide a planar antenna and an antenna device mounted with a metal-insulator phase transition element that can be temperature controlled by using a thin film transistor circuit.

### SUMMARY

A planar antenna according to one aspect of the present disclosure includes an antenna substrate on which at least one patch antenna, a signal line connected to the patch antenna, and a metal-insulator phase transition element provided on the signal line are arranged, and a temperature control substrate including a thin film transistor circuit and in which at least one heat generating element whose temperature is controlled by the thin film transistor circuit is disposed, wherein the antenna substrate and the temperature control substrate are laminated such that heat of the heat generating element can be conducted to the metal-insulator phase transition element.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a planar antenna in the present disclosure;

FIG. 2 is a conceptual diagram illustrating a cross section of a portion of the planar antenna in the present disclosure;

FIG. 3 is a conceptual diagram illustrating an example of a positional relationship between a phase transition switch and a heat generating element included in the planar antenna in the present disclosure;

FIG. 4 illustrates an example of a state in which the heat generating element associated with the phase transition switch included in the planar antenna in the present disclosure generates heat;

FIG. 5 is a conceptual diagram illustrating an example of a configuration of an antenna substrate included in the planar antenna in the present disclosure;

FIG. 6 is a conceptual diagram illustrating an example of a configuration of the antenna substrate included in the planar antenna in the present disclosure;

FIG. 7 is a conceptual diagram illustrating an example of a heat conduction structure included in the planar antenna in the present disclosure;

FIG. 8 is a conceptual diagram illustrating an example of the heat conduction structure included in the planar antenna in the present disclosure;

FIG. 9 is a conceptual diagram illustrating an example of the heat conduction structure included in the planar antenna in the present disclosure;

FIG. 10 is a conceptual diagram illustrating an example of an extending structure of a phase shifter included in the planar antenna in the present disclosure;

FIG. 11 is a conceptual diagram illustrating an example of a configuration of a planar antenna in the present disclosure;

FIG. 12 is a conceptual diagram showing a cross section of a portion of the planar antenna in the present disclosure;

FIG. 13 is a conceptual diagram illustrating an example of a positional relationship between a phase transition switch and a heat generating element included in the planar antenna of the present disclosure;

FIG. 14 is a conceptual diagram illustrating an example of the heat conduction structure included in the planar antenna in the present disclosure;

FIG. 15 is a conceptual diagram illustrating an example of an extending structure of a phase shifter included in the planar antenna in the present disclosure;

FIG. 16 is a conceptual diagram illustrating an example of a configuration of an antenna device in the present disclosure;

FIG. 17 is a block diagram illustrating an example of a configuration of the antenna device in the present disclosure;

FIG. 18 is a conceptual diagram illustrating an example of a configuration of the planar antenna in the present disclosure; and

FIG. 19 is a block diagram illustrating an example of a hardware configuration that executes control in the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, a planar antenna according to a first example embodiment will be described with reference to the drawings. The planar antenna of the present example embodiment includes a planar-type patch antenna. Hereinafter, description of transmission control for transmitting a radio wave from the planar antenna and reception control for receiving a radio wave received by the planar antenna will be omitted. For example, the planar antenna of the present example embodiment is used for transmission/reception of electromagnetic waves in a high frequency band predicted to be applied to mobile communication of B5G (Beyond 5 Generation) following 5G (5 Generation). For example, the planar antenna of the present example embodiment is used for transmission/reception of signals of millimeter waves or terahertz waves. The planar antenna of the present example embodiment may be used for transmission/reception of signals other than millimeter waves and terahertz waves.

### (Configuration)

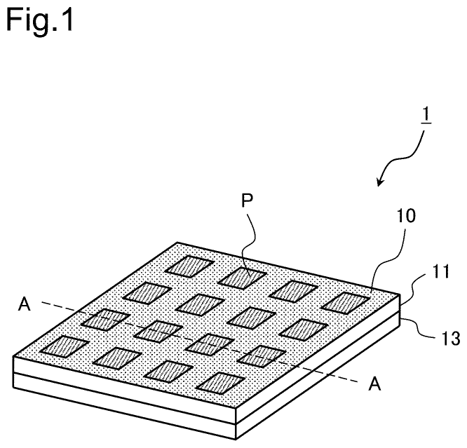

FIG. 1 is a conceptual diagram illustrating an example of a configuration of a planar antenna in the present disclosure. FIG. 1 illustrates an example of an external appearance of a planar antenna. A planar antenna 1 includes an antenna substrate 11 and a temperature control substrate 13. An antenna array 10 including a plurality of patch antennas P is arranged on an upper surface of the antenna substrate 11. The plurality of patch antennas P constituting the antenna array 10 are arrayed in a two-dimensional array shape. The plurality of patch antennas P are phased arrayed. Each of the patch antennas P constitutes an antenna element. Each antenna element is independently controlled. The temperature control substrate 13 includes a TFT circuit (not illustrated) including a thin film transistor (TFT). The TFT circuit is used to select a patch antenna P used for transmission/reception of radio waves. In the present example embodiment, description on a control circuit or the like that controls the planar antenna 1 is omitted.

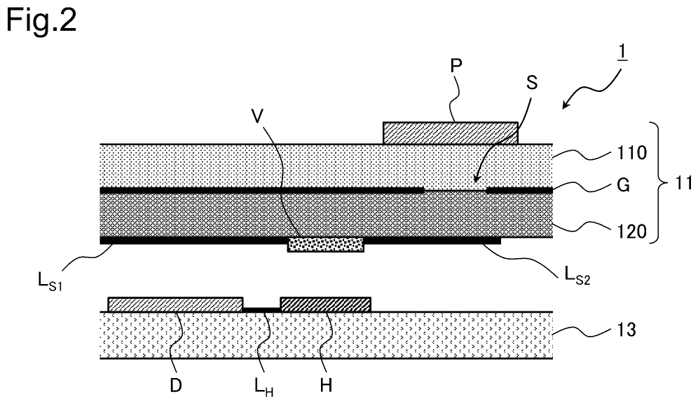

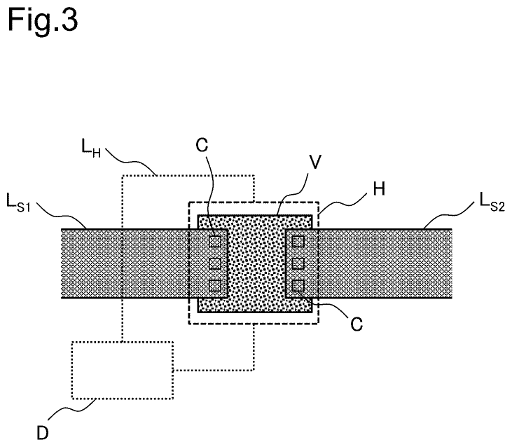

FIG. 2 is a conceptual diagram illustrating a cross section of a portion of the planar antenna in the present disclosure. FIG. 2 illustrates a cross section of the planar antenna cut along a cutting line A-A illustrated in FIG. 1. FIG. 3 is a conceptual diagram illustrating an example of a positional relationship between a phase transition switch and a heat generating element included in the planar antenna in the present disclosure. FIG. 3 is a plan view of the planar antenna viewed from an upper viewing seat. A phase transition switch V is disposed above a heat generating element H. The phase transition switch V is electrically connected to a first signal line L_{S1} and a second signal line L_{S2} by a contact structure C. In the configuration illustrated in FIG. 3, a temperature control line for controlling the temperature of the heat generating element intersects a signal line through which the phase-shifted signal propagates. Therefore, at a portion where the temperature control line and the signal line intersect with each other, a shield structure (not illustrated) for avoiding crosstalk is disposed between the temperature control line and the signal line.

FIGS. 2 to 3 illustrate one of the plurality of antenna elements constituting the planar antenna. The phase transition switch V is disposed on a lower surface of the antenna substrate 11. The heat generating element H is disposed on an upper surface of the temperature control substrate 13. The phase transition switch and the heat generating element H are disposed at positions facing each other. The phase transition switch V and the heat generating element H are disposed at intervals. An interval between the phase transition switch V and the heat generating element H is set to a distance at which heat radiated from the heat generating element H can be conducted to the phase transition switch V.

The phase transition switch V contains the vanadium dioxide. The vanadium dioxide causes a phase transition of an insulating phase-metal phase at around 67° C. The phase transition switch V is a phase transition switch utilizing a phase transition of the insulating phase-metal phase of the vanadium dioxide. That is, the phase transition switch V is an example of a phase transition element utilizing metal-insulator phase transition. The phase transition switch V may be made of a material other than the vanadium dioxide. For example, the phase transition switch V may be made of a material such as a composite oxide containing the vanadium dioxide or an oxide containing a 3d transition metal. A material having a transition temperature corresponding to the temperature of the use environment of the planar antenna may be applied to the phase transition switch V.

For example, the phase transition switch V is formed by using a sputtering method having metal vanadium or the vanadium dioxide as a target. For example, the phase transition switch V is formed by using a pulsed laser method having the vanadium dioxide as a target. For example, the phase transition switch V may be formed by using a sol-gel method, an inkjet method, screen printing, or the like. In any method, it is necessary to perform annealing at a high temperature in order to form the phase transition switch V containing the vanadium dioxide that undergoes a phase transition of the insulating phase-metal phase.

The phase transition switch V contains the vanadium dioxide that undergoes phase transition from an insulating phase to a metal phase at a phase transition temperature. For example, the phase transition switch V contains the vanadium dioxide to which no additive element is added. The ratio between oxygen and vanadium contained in the vanadium dioxide is adjusted to a ratio at which the phase transition of insulating phase-metal phase occurs. For example, an additive element may be added to the vanadium dioxide contained in the phase transition switch V. For example, when an additive element such as tungsten, magnesium, tantalum, iron, molybdenum, fluorine, or niobium is added to the vanadium dioxide, the phase transition temperature decreases. For example, when chromium, aluminum, or germanium is added to the vanadium dioxide, the phase transition temperature increases.

The vanadium dioxide is an insulating phase at a temperature lower than the phase transition temperature. Therefore, the phase transition switch V is in the OFF state at a temperature lower than the phase transition temperature. The vanadium dioxide is in a metal phase at a temperature higher than the phase transition temperature. Therefore, the phase transition switch V is in the ON state at a temperature higher than the phase transition temperature. A resistance change in the phase transition of the insulating phase-metal phase of the vanadium dioxide shows hysteresis characteristics. Therefore, in consideration of the hysteresis characteristics, the temperature of the phase transition switch V is adjusted in such a way as to cross the phase transition temperature.

The temperature of the heat generating element H associated with the phase transition switch V is controlled according to selection via the TFT circuit. The heat generating element H is made of a raw material having a large electric resistance that easily generates heat by energization. For example, the heat generating element H is made of a raw material containing a nickel-chromium alloy, a chromium-iron-aluminum alloy, or the like. The selected heat generating element H is configured to generate heat to a temperature at which the vanadium dioxide contained in the associated phase transition switch V undergoes the phase transition to a metal phase. In a state where the heat generating element H does not generate heat, the vanadium dioxide is in an insulating phase state. In a state where the vanadium dioxide is in an insulating phase, the phase transition switch V is in the OFF state.

When the selected heat generating element H generates heat, the temperature of the vanadium dioxide contained in the phase transition switch V rises by the heat radiated from the heat generating element H. When the temperature of the vanadium dioxide contained in the phase transition switch V exceeds the phase transition temperature, the vanadium dioxide undergoes the phase transition from the insulating phase to the metal phase. When the vanadium dioxide contained in the phase transition switch V undergoes the phase transition to the metal phase, the phase transition switch V transits to the ON state. When the heat generation of the heat generating element H stops and the temperature of the vanadium dioxide falls below the phase transition temperature, the vanadium dioxide undergoes the phase transition from the metal phase to the insulating phase. When the vanadium dioxide contained in the phase transition switch V undergoes the phase transition to the insulating phase, the phase transition switch V transits to the OFF state.

The antenna substrate 11 includes a first substrate 110 and a second substrate 120. The first substrate 110 and the second substrate 120 are insulators (dielectrics). The first substrate 110 and the second substrate 120 are made of a material having a low dielectric loss. The first substrate 110 and the second substrate 120 are preferably made of a raw material having high insulating property and low dielectric loss, such as a ceramic material or glass. The first substrate 110 and the second substrate 120 may be made of a polymer or a synthetic material. Electromagnetic waves such as high frequency waves and microwaves can be effectively controlled the lower the dielectric loss of the first substrate 110 and the second substrate 120. For example, at least one of the first substrate 110 and the second substrate 120 includes a multilayer substrate having a small transmission loss. For example, at least one of the first substrate 110 and the second substrate 120 may be made of an alumina substrate.

The patch antenna P is arranged on an upper surface of the first substrate 110. A ground layer G is disposed between a lower surface of the first substrate 110 and an upper surface of the second substrate 120. The ground layer G is formed with a slot S. The slot S is formed below the patch antenna P. The phase transition switch V is disposed on a lower surface of the second substrate 120. In addition, the first signal line L_{S1} and the second signal line L_{S2} connected to the phase transition switch V are arranged on the lower surface of the second substrate 120. The first signal line L_{S1} is connected to a signal source (not illustrated) via a phase shift wiring (not illustrated). The first signal line L_{S1} is a line through which the phase-shifted signal is propagated by the phase shift wiring. The second signal line L_{S2} is extended to below the patch antenna P. The second signal line L_{S2} is a line for propagating the phase-shifted signal after the phase shift to the patch antenna P. The slot S is interposed between the second signal line L_{S2} and the patch antenna P. A layer in which the phase transition switch V, the first signal line L_{S1}, and the second signal line L_{S2} are arranged forms a phase shift layer.

The patch antenna P is a plate-shaped radiation element. For example, the patch antenna P has a square shape. The shape of the patch antenna P is not limited to a square shape, and may be a circular shape or other shapes. The patch antenna P is power fed by an electromagnetic coupling feeding method. The patch antenna P is electromagnetically coupled to the second signal line L_{S2} formed on the lower surface of the second substrate 120 via the slot S. The patch antenna P is excited by electromagnetic coupling between the patch antenna P and the second signal line L_{S2} via the slot S. The patch antenna P has a structure equivalent to that of a microstrip line whose both ends are opened. The resonance frequency of the patch antenna P is an integral multiple of a wavelength corresponding to the length of one side of the patch antenna P. The size of the patch antenna P is set according to the wavelength of the transmission target radio wave. The patch antenna P may be configured to be wired connected to the second signal line L_{S2} via an electric conductor. In addition, the patch antenna P may be formed on the same plane as the second signal line L_{S2} and may be configured to be directly connected to the second signal line L_{S2}. In this case, the phase shift line disposed in the phase shift layer and the second signal line L_{S2} are electromagnetically coupled.

The ground layer G is disposed between the first substrate 110 and the second substrate 120. The ground layer G may be formed on the lower surface of the first substrate 110 or may be formed on the upper surface of the second substrate 120. The ground layer G blocks electromagnetic coupling above and below the ground layer G. The ground layer G is made by an electric conductor. For example, the raw material of the ground layer G is a metal (including an alloy) such as copper, aluminum, or chromium. The potential of the ground layer G is a ground potential. Therefore, a capacitance corresponding to a dielectric constant of the second substrate 120 is formed between the phase shift layer and the ground layer G, the phase shift layer including the phase transition switch V, the first signal line L_{S1}, the second signal line L_{S2}, and the phase shift wiring (not illustrated).

The temperature control substrate 13 is a substrate on which the TFT circuit is formed. For example, a raw material of the temperature control substrate 13 is an insulator (dielectric). The temperature control substrate 13 is made of a material having a low dielectric loss. For example, the temperature control substrate 13 is made of a raw material having high insulating property and low dielectric loss, such as ceramic material or glass. The temperature control substrate 13 may be made of a polymer or a synthetic material. Electromagnetic waves such as high frequency waves and microwaves can be effectively controlled the lower the dielectric loss of the temperature control substrate 13. For example, the temperature control substrate 13 includes a multilayer substrate having a small transmission loss. For example, the temperature control substrate 13 may include an alumina substrate.

A drive circuit D and the heat generating element H are disposed on the upper surface of the temperature control substrate 13. The drive circuit D and the heat generating element H are connected by a temperature control line LH. The drive circuit D is an element constituting the TFT circuit. TFT wiring (not illustrated) for controlling the temperature of the heat generating element H is formed in the layer in which the heat generating element H is disposed. The TFT wiring includes a plurality of selection lines used to select the drive circuit D (phase shifter) and a plurality of data lines used to write phase shift data to the phase shifter. When the drive circuit D is selected, the heat generating element H generates heat. The heat of the heat generating element H is conducted to the phase transition switch V disposed above the heat generating element H. A resistance change in the phase transition of the insulating phase-metal phase of the vanadium dioxide shows hysteresis characteristics. Therefore, in consideration of the hysteresis characteristics, the temperature of the heat generating element H is controlled in such a way that the temperature of the phase transition switch V crosses the phase transition temperature.

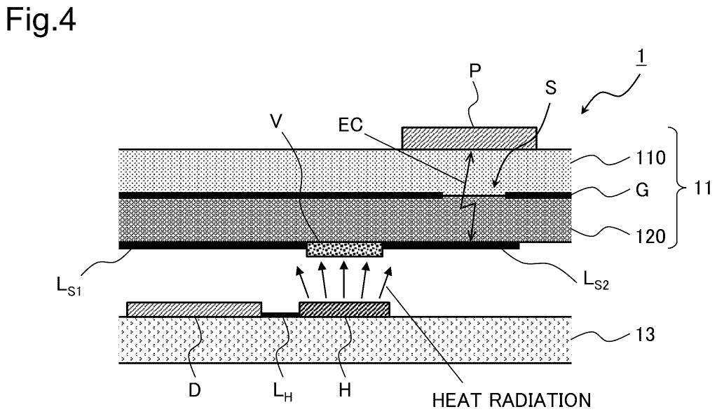

FIG. 4 illustrates an example of a state in which the heat generating element associated with the phase transition switch included in the planar antenna in the present disclosure generates heat. When the drive circuit D is selected, the heat generating element H generates heat. The temperature of the phase transition switch V rises due to heat radiation from the heat generating element H that has generated heat. When the temperature of the phase transition switch V exceeds the phase transition temperature of the insulating phase-metal phase, the phase transition switch V transitions to ON. When the phase transition switch V transitions to ON, the radio wave transmitted from the signal source propagates to the second signal line L_{S2} via the phase shift wiring and the first signal line L_{S1}. The radio wave propagated to the second signal line L_{S2} is propagated to the patch antenna P by electromagnetic coupling. The signal propagated to the patch antenna P is transmitted as a radio signal from the phased array antenna configured by the plurality of patch antennas P.

The antenna substrate 11 and the temperature control substrate 13 are manufactured using different manufacturing processes. The antenna substrate 11 is annealed at a high temperature to form the phase transition switch V containing the vanadium dioxide that undergoes metal-insulator phase transition. On the other hand, the temperature control substrate 13 is manufactured by using a TFT manufacturing step included in a liquid crystal panel manufacturing step. The antenna substrate 11 and the temperature control substrate 13 are laminated to each other such that the phase transition switch V and the heat generating element H associated with each other face each other. By laminating the antenna substrate 11 and the temperature control substrate 13 to each other, a phase shifter including the phase transition switch V and the heat generating element H are formed. The phase shift amount of the formed phase shifter is set according to the length of the phase shift wiring. The structure of the phase shift wiring and the phase shift amount are not limited.

When the antenna substrate 11 and the temperature control substrate 13 are collectively manufactured, a step of applying an additional high temperature after the manufacturing process of the TFT circuit is finished is included in order to form the phase transition switch V on the temperature control substrate 13. When such a high temperature is applied to the temperature control substrate 13, the TFT circuit included in the temperature control substrate 13 may be damaged. Since the antenna substrate 11 and the temperature control substrate 13 are manufactured using different manufacturing processes in the planar antenna 1, no additional high temperature is applied to the temperature control substrate 13 after the manufacturing process of the TFT circuit is finished. Therefore, the TFT circuit included in the temperature control substrate 13 is not damaged. That is, according to the present example embodiment, a planar antenna on which the phase transition switch (phase transition element) capable of being subjected to temperature control by the TFT circuit is mounted can be achieved.

### (Antenna Substrate)

Next, a specific example of an antenna substrate included in the planar antenna in the present example embodiment will be described with reference to the drawings. Hereinafter, an antenna type in which the first substrate includes an alumina substrate and a device transfer type manufactured using device transfer will be described. The following example is an example of an antenna substrate and does not limit the antenna substrate in the present example embodiment.

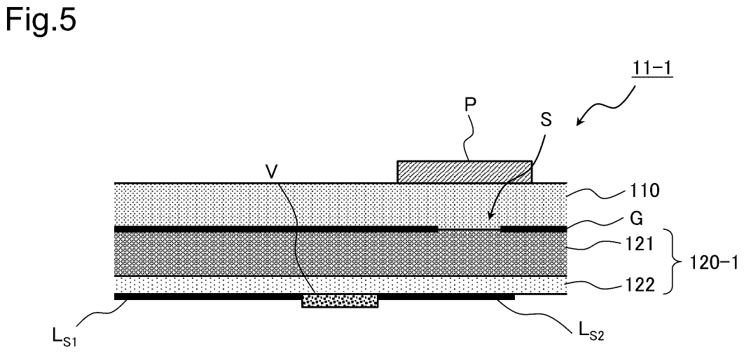

FIG. 5 is a conceptual diagram illustrating an example of a configuration of an antenna substrate included in the planar antenna in the present disclosure. FIG. 5 illustrates a cross-sectional view of the antenna substrate. An antenna substrate 11-1 includes the first substrate 110 and a second substrate 120-1. The first substrate 110 illustrated in FIG. 5 is similar to the first substrate 110 illustrated in FIG. 2. The second substrate 120-1 includes two layers of an alumina substrate 121 and a silica layer 122. The material of the alumina substrate 121 is aluminum oxide. The silica layer 122 is formed on the lower surface of the alumina substrate 121. The material of the silica layer 122 is silicon dioxide. The ground layer G is formed on the lower surface of the first substrate 110. The lower surface of the ground layer G and the upper surface of the alumina substrate 121 are joined to form the antenna substrate 11-1. The phase shift layer including the phase transition switch V, the first signal line L_{S1}, the second signal line L_{S2}, and the phase shift wiring (not illustrated) is formed on the lower surface of the silicon dioxide. The alumina substrate 121 has an advantage that a material having a low dielectric loss can be selected. However, since the alumina substrate 121 has a large thermal conductivity, there is a disadvantage that the heat of the heat generating element H is easily diffused upward. In the antenna substrate 11-1, the silica layer 122 is interposed between the alumina substrate 121 and the phase transition switch V. Therefore, the heat of the heat generating element H is insulated by the silica layer 122 and is less likely to be diffused to the alumina substrate 121. According to the configuration of FIG. 5, an antenna substrate including an alumina substrate having a low dielectric loss can be achieved.

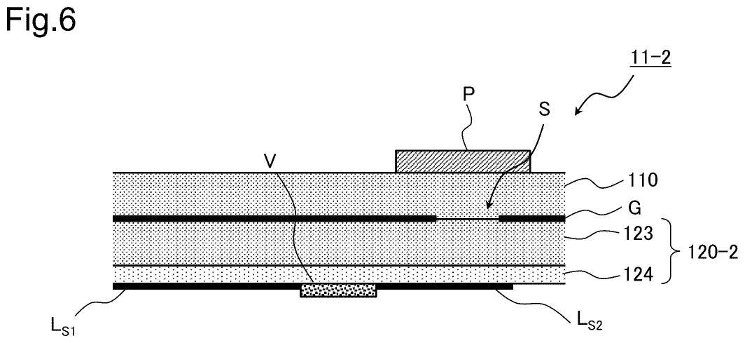

FIG. 6 is a conceptual diagram illustrating an example of a configuration of the antenna substrate included in the planar antenna in the present disclosure. FIG. 6 illustrates a cross-sectional view of the antenna substrate. An antenna substrate 11-2 includes the first substrate 110 and a second substrate 120-2. The first substrate 110 illustrated in FIG. 6 is similar to the first substrate 110 illustrated in FIG. 2. The second substrate 120-2 includes two layers of a dielectric substrate 123 and a silicon substrate 124. A material of the dielectric substrate 123 is a ceramic material, a glass, a polymer, or a synthetic material. The silicon substrate 124 is formed on the lower surface of the dielectric substrate 123. The material of the silicon substrate 124 is silicon. The phase shift layer including the phase transition switch V, the first signal line L_{S1}, the second signal line L_{S2}, and the phase shift wiring (not illustrated) is formed on the lower surface of the silicon substrate 124. The phase shift layer including the phase transition switch V, the first signal line L_{S1}, the second signal line L_{S2}, and the phase shift wiring is formed on the surface of the silicon substrate 124 by using a device transfer technique which is a process technique of a micro light emitting diode (LED). That is, the phase transition switch V, the first signal line L_{S1}, the second signal line L_{S2}, the phase shift wiring, and the like are transfer devices. The phase shift layer including the phase transition switch V, the first signal line L_{S1}, the second signal line L_{S2}, the phase shift wiring, and the like, which are transfer devices, are formed on the silicon substrate and formed into chips. The chipped phase transition switch V, the first signal line L_{S1}, the second signal line L_{S2}, the phase shift wiring, and the like are transferred to the surface of the silicon substrate 124. The ground layer G is formed on the upper surface of the dielectric substrate 123.

The lower surface of the first substrate 110 and the upper surface of the ground layer G and the lower surface of the dielectric substrate 123 and the upper surface of the silicon substrate 124 are joined to form the antenna substrate 11-2. The configuration of FIG. 6 can simplify the manufacturing process of a fine device by using the device transfer technique.

### (Heat Conduction Structure)

Next, an example of a heat conduction structure included in the planar antenna in the present example embodiment will be described with reference to the drawings. The heat conduction structure is a structure that mediates heat conduction between the phase transition switch included in the planar antenna and the heat generating element. In the following description of the heat conduction structure, the antenna substrate is illustrated as a single substrate, and wiring around the phase transition switch V and the heat generating element H is omitted. The following example is an example of a heat conduction structure included in the planar antenna and does not limit the heat conduction structure in the present example embodiment.

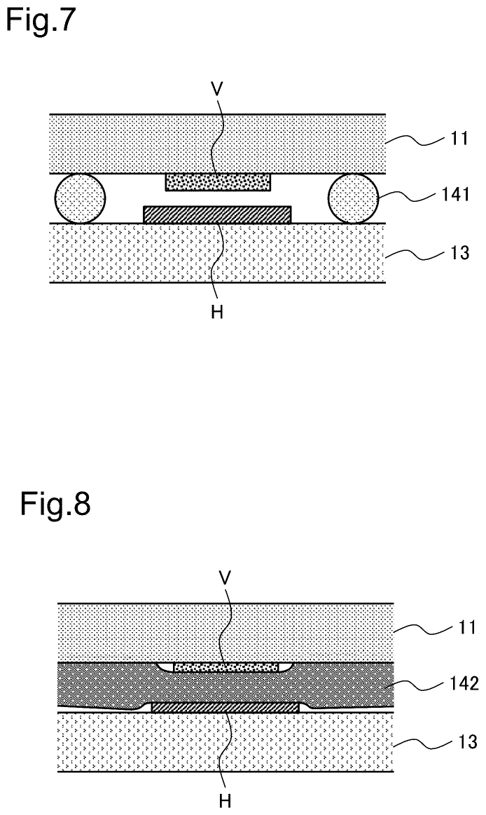

FIG. 7 is a conceptual diagram illustrating an example of a heat conduction structure included in the planar antenna in the present disclosure. FIG. 7 illustrates a cross-sectional view of the planar antenna. A spacer 141 is disposed between the antenna substrate 11 and the temperature control substrate 13. For example, the spacer 141 is formed using a liquid crystal process. For example, the spacer 141 can be formed by spreading a spherical member at the periphery of the phase transition switch V and the heat generating element H and precisely controlling the interval between the antenna substrate 11 and the temperature control substrate 13 to be a desired gap. For example, the spacer 141 may be formed by patterning a resin. For example, the spacer 141 may be formed by sandblasting. The spacer 141 may be formed in such a way as to surround the periphery of the phase transition switch V and the heat generating element H associated with each other. In this case, the spacer 141 can be formed in such a way as to indicate a closed figure such as a square, a rectangle, a polygon, a circle, or an ellipse in plan view. The interval between the phase transition switch V and the heat generating element H is adjusted by the size of the spacer 141. For example, the interval between the phase transition switch V and the heat generating element H is adjusted to a gap of 10 μm (micrometers) to several tens of μm. For example, the spacer 141 may be configured to seal the periphery of the phase transition switch V and the heat generating element H. With such a configuration, the space between the phase transition switch V and the heat generating element H can be depressurized, or a gas having a high thermal conductivity can be sealed. In the heat conduction structure of FIG. 7, the heat generated from the heat generating element H can be configured to be conducted to the phase transition switch V via the gas filling the space between the antenna substrate 11 and the temperature control substrate 13. That is, in the heat conduction structure of FIG. 7, the heat generated from the heat generating element H can be conducted to the phase transition switch V by heat radiation through the space.

FIG. 8 is a conceptual diagram illustrating an example of the heat conduction structure included in the planar antenna in the present disclosure. FIG. 8 illustrates a cross-sectional view of the planar antenna. A heat conductive sheet 142 is disposed between the antenna substrate 11 and the temperature control substrate 13. The heat conductive sheet 142 is made of a material having high thermal conductivity. The heat conductive sheet 142 may be a small piece that fits within planes of the phase transition switch V and the heat generating element H. For example, the heat conductive sheet 142 is configured to be in contact with both the antenna substrate 11 and the temperature control substrate 13. For example, it may be configured to be in contact with either one of the antenna substrates 11 and the temperature control substrate 13. When the interval between the antenna substrate 11 and the temperature control substrate 13 is sufficiently small, the heat conductive sheet 142 may be configured to be in contact with either one of the phase transition switch V and the heat generating element H. In addition, the heat conductive sheet 142 may be configured not to be in contact with both the antenna substrate 11 and the temperature control substrate 13. The heat conductive sheet 142 is interposed between the phase transition switch V and the heat generating element H. For example, the interval between the phase transition switch V and the heat generating element H is adjusted according to the thickness of the heat conductive sheet 142. For example, the heat conductive sheet 142 may be configured for joining the antenna substrate 11 and the temperature control substrate 13. For example, the heat conductive sheet 142 may be transferred to either one of the phase transition switch V and the heat generating element H using a manufacturing process of the micro LED. When antenna substrate 11 and temperature control substrate 13 are laminated to each other in a state where heat conductive sheet 142 is transferred to either the phase transition switch V or the heat generating element H, the antenna substrate 11 and the temperature control substrate 13 can be joined to each other. In the heat conduction structure of FIG. 8, heat generated from the heat generating element H is conducted to the phase transition switch V via the heat conductive sheet 142. That is, in the heat conduction structure of FIG. 8, the heat generated from the heat generating element H is conducted to the phase transition switch V by heat conduction through the heat conductive sheet 142.

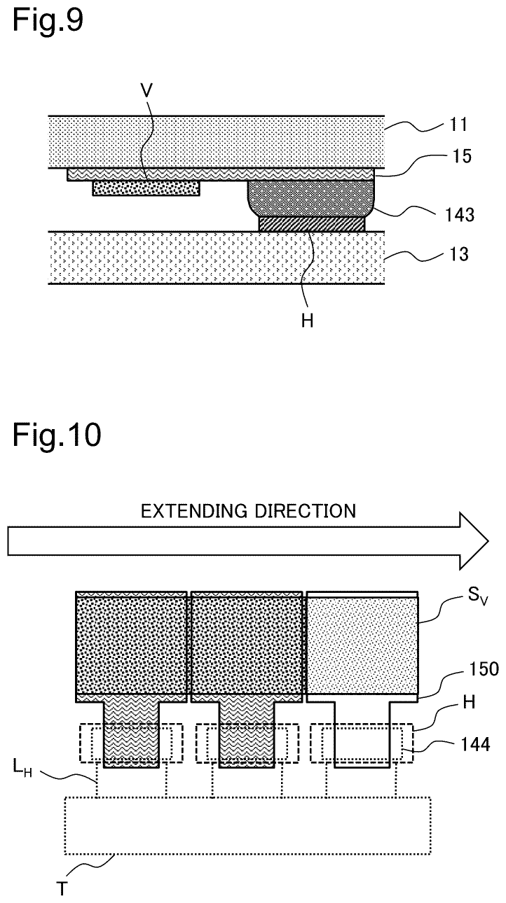

FIG. 9 is a conceptual diagram illustrating an example of the heat conduction structure included in the planar antenna in the present disclosure. FIG. 9 illustrates a cross-sectional view of the planar antenna. A heat conductive layer 15 is disposed on a lower surface of the antenna substrate 11. For example, the heat conductive layer 15 is made of a material having a high thermal conductivity such as alumina or silicon carbide. The phase transition switch V is disposed on a lower surface of the heat conductive layer 15. Furthermore, a heat conductor 143 is disposed on a lower surface of the heat conductive layer 15. For example, the heat conductor 143 is formed by printing a grease-like heat conductive material by screen printing. The heat generating element H disposed on the upper surface of the temperature control substrate 13 is disposed at a position deviated from below the phase transition switch V. The heat generating element H is disposed below the heat conductor 143. The heat conductor 143 and the heat conductive layer 15 are interposed between the phase transition switch V and the heat generating element H. The heat generating element H is thermally connected to the phase transition switch V via the heat conductor 143 and the heat conductive layer 15. For example, the heat conductor 143 may be configured for joining the antenna substrate 11 and the temperature control substrate 13. In the heat conduction structure of FIG. 9, heat generated from the heat generating element H is conducted to the phase transition switch V via the heat conductor 143 and the heat conductive layer 15. That is, in the heat conduction structure of FIG. 9, the heat generated from the heat generating element H is conducted to the phase transition switch V by heat conduction through the heat conductor 143 and the heat conductive layer 15.

### (Phase Shifter)

Next, an example of a phase shifter extending structure included in the planar antenna in the present example embodiment will be described with reference to the drawings. In the extending structure, a phase transition line is shared among a plurality of adjacent heat conductive layers. The line length of the phase transition line is controlled by temperature control of the heat generating element H for each heat conductive layer.

FIG. 10 is a conceptual diagram illustrating an example of an extending structure of a phase shifter included in the planar antenna in the present disclosure. FIG. 10 is a plan view of a portion (phase shift wiring) of the phase shifter viewed from an upper viewing seat. FIG. 10 illustrates a part of the phase shift wiring that has the same switching structure as that of FIG. 9 and is extendable the line length according to the selection of the heat generating element. For example, the phase shifter is a line length variable phase shifter in which a plurality of phase shift wirings having different line lengths are branched from a main wiring in a side chain form. For example, the phase shift wiring is a stub having an open end. An openable/closable selection switch (not illustrated) is disposed at a contact point between the plurality of phase shift wiring and the main wiring. The phase shift wiring is selected according to opening/closing of a selection switch disposed at a contact point with the main wiring. The selection switch may be configured by a phase transition switch. The line length of the phase shift wiring is set according to the selection control of the heat generating element H. The phase shift wiring includes a phase transition line S_{V} extending along the extending direction. The phase shift wiring includes a plurality of heat conductive layers 150 arrayed along the extending direction. The phase transition line S_{V} is disposed across the plurality of heat conductive layers 150. The phase transition line S_{V} contains a vanadium dioxide that undergoes phase transition from an insulating phase to a metal phase at a phase transition temperature. Each of the plurality of heat conductive layers 150 is thermally connected to the heat generating element H via a heat conductor 144. The heat generating element H connected to each of the plurality of heat conductive layers 150 generates heat according to the selection via the drive circuit T.

When the selection switch disposed at the contact point with the main wiring is selected and transitioned to the ON state, the phase shift line connected to the main wiring via the selection switch transitions to the ON state. When the heat generating element H connected to the phase shift wiring generates heat, the heat is conducted to the heat conductive layer 150 via the heat conductor 144 thermally connected to the heat generating element H. The heat conducted to the heat conductive layer 150 is conducted to the phase transition line S_{V} in contact with the heat conductive layer 150. When the temperature of the phase transition line S_{V} exceeds the phase transition temperature of the insulating phase-metal phase, the phase transition line S_{V} transitions to the metal phase. The phase transition line S_{V} that has phase transitioned to the metal phase functions as a line of phase shift wiring. In the example of FIG. 10, a state in which the second heat conductor, which is the first from the left, is selected is indicated by hatching. In this case, the line length of the phase shift wiring is extended from the contact point with the main wiring (not illustrated) to the portion of the phase transition line S_{V} thermally connected to the heat conductor second from the left in FIG. 10. When the temperature of the phase transition line S_{V} falls below the phase transition temperature of the insulating phase-metal phase, the phase transition line S_{V} undergoes phase transition to an insulating phase, and the line length of the phase shift wiring becomes short. In addition, when transitioned to the OFF state in which the selection of the selection switch disposed at the contact point with the main wiring is released, the phase shift line connected to the main wiring via the selection switch transitions to the OFF state.

In the configuration illustrated in FIG. 10, the temperature control substrate on which the temperature control line for controlling the temperature of the heat generating element is arranged and the antenna substrate on which the signal line through which the phase-shifted signal propagates is arranged are separated. Therefore, a shield structure for avoiding crosstalk between the temperature control line and the signal line is unnecessary.

As described above, the planar antenna of the present example embodiment includes the antenna substrate and the temperature control substrate. The antenna substrate is provided with at least one patch antenna, a signal line connected with the patch antenna, and a metal-insulator phase transition element provided on the signal line. The plurality of patch antennas P are arrayed in a two-dimensional array shape. For example, the patch antenna and the signal line are connected by electromagnetic coupling. For example, the antenna substrate includes a ground layer in which an opening for electromagnetically coupling the patch antenna and the signal line is formed below the patch antenna. The signal line includes a first signal line and a second signal line. The first signal line is connected to a signal source via a phase shifter related to each of the plurality of patch antennas. The second signal line is extended to below the plurality of patch antennas. The second signal line is configured to couple with the patch antenna by electromagnetic coupling. The metal-insulator phase transition element is disposed between the first signal line and the second signal line. The temperature control substrate includes a thin film transistor circuit, and at least one heat generating element H whose temperature is controlled by the thin film transistor circuit is disposed. The antenna substrate and the temperature control substrate are laminated to each other such that heat of the heat generating element can be conducted to the metal-insulator phase transition element. An antenna element including one patch antenna, one metal-insulator phase transition element, and one heat generating element constitutes a phased array antenna.

In the planar antenna of the present example embodiment, the antenna substrate and the temperature control substrate can be manufactured by using different manufacturing processes. Therefore, an additional high temperature is not applied to the temperature control substrate after the manufacturing process of the TFT circuit is finished, and the thin film transistor circuit included in the temperature control substrate is not damaged. That is, according to the present example embodiment, a planar antenna on which a metal-insulator phase transition element whose temperature can be controlled using a thin film transistor circuit is mounted can be achieved.

In one aspect of the present example embodiment, the metal-insulator phase transition element is a phase transition switch containing a vanadium dioxide. The heat generating element is configured to generate heat to a temperature exceeding a phase transition temperature at which the vanadium dioxide undergoes phase transition from an insulating phase to a metal phase according to the temperature control of the thin film transistor circuit. According to the present aspect, a planar antenna in which a metal-insulator phase transition element is made of vanadium dioxide can be provided.

In one aspect of the present example embodiment, a spacer is disposed between the antenna substrate and the temperature control substrate in such a way as to surround the metal-insulator phase transition element and the heat generating element. According to the present aspect, the heat of the heat generating element is easily and efficiently conducted to the metal-insulator phase transition element by sealing the space where the metal-insulator phase transition element and the heat generating element are disposed.

In one aspect of the present example embodiment, a heat conductive sheet is disposed between the metal-insulator phase transition element and the heat generating element. According to the present aspect, the heat of the heat generating element is easily and efficiently conducted to the metal-insulator phase transition element by thermally connecting the metal-insulator phase transition element and the heat generating element by way of the heat conductive sheet.

In one aspect of the present example embodiment, a heat conductive layer is formed between the antenna substrate and the metal-insulator phase transition element. In a plan view, the metal-insulator phase transition element and the heat generating element are disposed in a positional relationship in which they do not overlap each other. A heat conductor is disposed between the heat generating element and the heat conductive layer. According to the present aspect, the heat of the heat generating element is easily and efficiently conducted to the metal-insulator phase transition element by thermally connecting the metal-insulator phase transition element and the heat generating element by way of the heat conductive layer and the heat conductor. In addition, in the present aspect, since the metal-insulator phase transition element and the heat generating element do not overlap each other in a plan view, a degree of freedom in designing dielectric characteristics and the like increases.

### Second Example Embodiment

First, a planar antenna according to a second example embodiment will be described with reference to the drawings. The planar antenna of the present example embodiment is configured such that the phase transition switch and the heat generating element be in contact with each other. Hereinafter, the description of a configurations similar to those of the first example embodiment will be omitted.

### (Configuration)

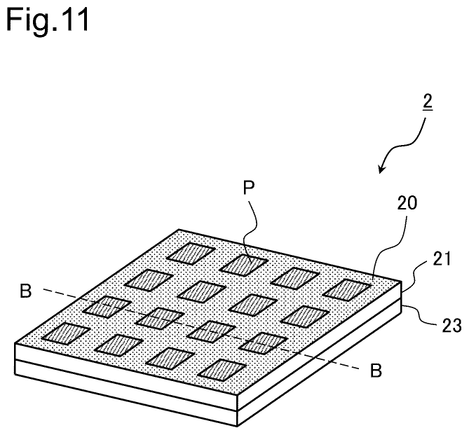

FIG. 11 is a conceptual diagram illustrating an example of a configuration of a planar antenna in the present disclosure. FIG. 11 illustrates an example of an external appearance of the planar antenna. The planar antenna 2 includes an antenna substrate 21 and a temperature control substrate 23. An antenna array 20 including a plurality of patch antennas P is arranged on an upper surface of the antenna substrate 21. The plurality of patch antennas P constituting the antenna array 20 are arrayed in a two-dimensional array shape. The plurality of patch antennas P are phased arrayed. Each of the patch antennas P constitutes an antenna element. Each antenna element is independently controlled. The temperature control substrate 23 includes a TFT circuit (not illustrated) including a thin film transistor (TFT). The TFT circuit is used to select a patch antenna P used for transmission/reception of radio waves. In the present example embodiment, description on a control circuit or the like configured to control the planar antenna 2 will be omitted.

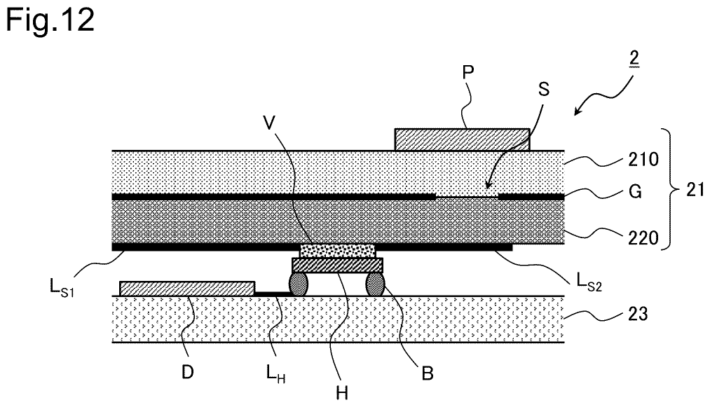

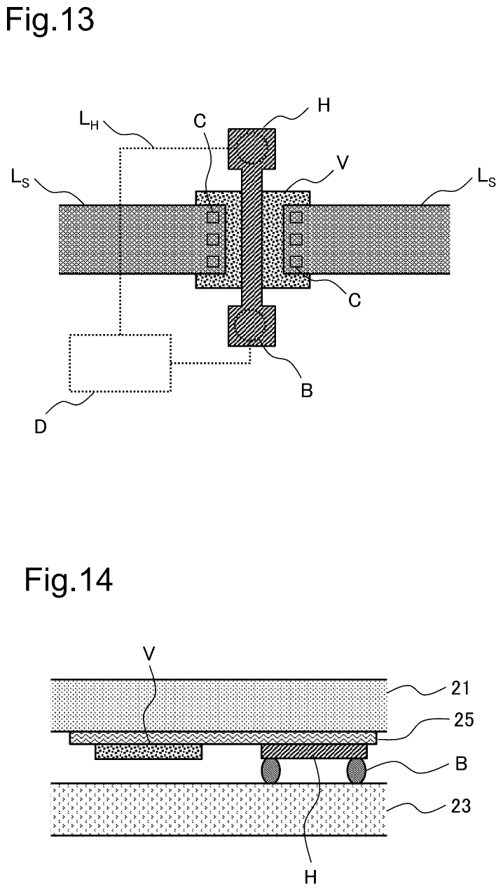

FIG. 12 is a conceptual diagram showing a cross section of a portion of the planar antenna in the present disclosure. FIG. 12 illustrates a cross section of the planar antenna cut along a cutting line B-B illustrated in FIG. 11. FIG. 13 is a conceptual diagram illustrating an example of a positional relationship between a phase transition switch and a heat generating element included in the planar antenna of the present disclosure. FIG. 13 is a plan view of the planar antenna viewed from an upper viewing seat. The heat generating element H is disposed on the lower surface of the phase transition switch V.

The phase transition switch V is electrically connected to a first signal line L_{S1} and a second signal line L_{S2} by a contact structure C. In the configuration illustrated in FIG. 13, a temperature control line for controlling the temperature of the heat generating element intersects a signal line through which the phase-shifted signal propagates. Therefore, at a portion where the temperature control line and the signal line intersect with each other, a shield structure (not illustrated) for avoiding crosstalk is disposed between the temperature control line and the signal line. In the structure of the present example embodiment, since the gap between the temperature control line and the signal line can be sufficiently provided, the shield structure may not be provided.

FIGS. 12 to 13 illustrate one of the plurality of antenna elements constituting the planar antenna. The phase transition switch V and the heat generating element H are disposed on the lower surface of the antenna substrate 21. The heat generating element H is formed on the lower surface of the phase transition switch V. A pair of bumps B is formed on an upper surface of the temperature control substrate 23. The pair of bumps B is connected to the heat generating element H. The heat generating element H has a rectangular shape extending along one direction. The heat generating element H is disposed across the phase transition switch V. The heat generating element H generates heat according to selection control via the pair of bumps B. The heat radiated from the heat generating element H is directly transmitted to the phase transition switch V.

The phase transition switch V has a similar configuration to that of the phase transition switch V of the first example embodiment. The phase transition switch V is temperature controlled similarly to the phase transition switch V of the first example embodiment. The phase transition switch V contains the vanadium dioxide that undergoes phase transition from an insulating phase to a metal phase at a phase transition temperature. The vanadium dioxide is an insulating phase at a temperature lower than the phase transition temperature. Therefore, the phase transition switch V is in the OFF state at a temperature lower than the phase transition temperature. The vanadium dioxide is in a metal phase at a temperature higher than the phase transition temperature. Therefore, the phase transition switch V is in the ON state at a temperature higher than the phase transition temperature. A resistance change in the phase transition of the insulating phase-metal phase of the vanadium dioxide shows hysteresis characteristics. Therefore, in consideration of the hysteresis characteristics, the temperature of the phase transition switch V is adjusted in such a way as to cross the phase transition temperature.

The antenna substrate 21 has a similar configuration to that of the antenna substrate 11 of the first example embodiment. The antenna substrate 21 includes a first substrate 210 and a second substrate 220. The patch antenna P is arranged on an upper surface of the first substrate 210. A ground layer G is disposed between a lower surface of the first substrate 210 and an upper surface of the second substrate 220. The ground layer G is formed with a slot S. The slot S is formed below the patch antenna P. The phase transition switch V is disposed on a lower surface of the second substrate 220. In addition, the first signal line L_{S1} and the second signal line L_{S2} connected to the phase transition switch V are arranged on the lower surface of the second substrate 220. The first signal line L_{S1} is connected to a signal source (not illustrated) via a phase shift wiring (not illustrated). The second signal line L_{S2} is extended to below the patch antenna P. The slot S is interposed between the second signal line L_{S2} and the patch antenna P. A layer in which the phase transition switch V, the first signal line L_{S1}, and the second signal line L_{S2} are arranged forms a phase shift layer.

The patch antenna P has a similar configuration to that of the patch antenna P of the first example embodiment. The patch antenna P is electromagnetically coupled to the second signal line L_{S2} formed on the lower surface of the second substrate 220 via the slot S. The patch antenna P is excited by electromagnetic coupling between the patch antenna P and the second signal line L_{S2} via the slot S. The patch antenna P may be configured to be wired connected to the second signal line L_{S2} via an electric conductor. In addition, the patch antenna P may be formed on the same plane as the second signal line L_{S2} and may be configured to be directly connected to the second signal line L_{S2}. In this case, the phase shift line disposed in the phase shift layer and the second signal line L_{S2} are electromagnetically coupled.

The ground layer G has a similar configuration to that of the ground layer of the first example embodiment. The ground layer G is disposed between the first substrate 210 and the second substrate 220. The ground layer G blocks electromagnetic coupling above and below the ground layer G. The potential of the ground layer G is a ground potential. Therefore, a capacitance corresponding to a dielectric constant of the second substrate 220 is formed between the phase shift layer and the ground layer G, the phase shift layer including the phase transition switch V, the first signal line L_{S1}, the second signal line L_{S2}, and the phase shift wiring (not illustrated). In the case of the structure of the present example embodiment, the ground layer G may be omitted.

The temperature control substrate 23 has a similar configuration to that of the temperature control substrate 13 of the first example embodiment. The drive circuit D is disposed on an upper surface of the temperature control substrate 23. The heat generating element H is connected to a pair of bumps B formed on the upper surface of the temperature control substrate 23. The bump B can be formed by a bump used in flip-chip mounting. The drive circuit D and the heat generating element H are connected by the temperature control line LH and the bump B. The drive circuit D is an element constituting the TFT circuit. In the layer in which the heat generating element H is disposed, a TFT wiring (not illustrated) for controlling the temperature of the heat generating element H in selection of the phase shifter to be controlled is formed. The TFT wiring includes a plurality of selection lines used to select the phase shifter and a plurality of data lines used to write phase shift data to the phase shifter. When the drive circuit D is selected, the heat generating element H generates heat. The heat of the heat generating element H is conducted to the phase transition switch V. A resistance change in the phase transition of the insulating phase-metal phase of the vanadium dioxide shows hysteresis characteristics. Therefore, in consideration of the hysteresis characteristics, the temperature of the heat generating element H is controlled in such a way that the temperature of the phase transition switch V crosses the phase transition temperature.

The antenna substrate 21 and the temperature control substrate 23 are manufactured using different manufacturing processes. The antenna substrate 21 is annealed at a high temperature to form the phase transition switch V containing the vanadium dioxide that undergoes metal-insulator phase transition. On the other hand, the temperature control substrate 23 is manufactured by using a TFT manufacturing step included in a liquid crystal panel manufacturing step. The antenna substrate 21 and the temperature control substrate 23 are laminated to each other such that the phase transition switch V and the heat generating element H associated with each other face each other. By laminating the antenna substrate 21 and the temperature control substrate 23 to each other, a phase shifter including the phase transition switch V and the heat generating element H is formed. The phase shift amount of the formed phase shifter is set according to the length of the phase shift wiring. The structure of the phase shift wiring and the phase shift amount are not limited.

When the antenna substrate 21 and the temperature control substrate 23 are collectively manufactured, a step of applying an additional high temperature after the manufacturing process of the TFT circuit is finished is included to form the phase transition switch V on the temperature control substrate 23. When such a high temperature is applied to the temperature control substrate 23, the TFT circuit included in the temperature control substrate 23 may be damaged. The planar antenna 2 is manufactured by using different manufacturing processes for the antenna substrate 21 and the temperature control substrate 23. Therefore, an additional high temperature is not applied to the temperature control substrate 23 after the manufacturing process of the TFT circuit is finished, and the TFT circuit included in the temperature control substrate 23 is not damaged. That is, according to the present example embodiment, a planar antenna on which the phase transition switch (phase transition element) capable of being subjected to temperature control by the TFT circuit is mounted can be achieved.

### (Heat Conduction Structure)

Next, an example of a heat conduction structure included in the planar antenna in the present example embodiment will be described with reference to the drawings. The heat conduction structure is a structure that mediates heat conduction between the phase transition switch included in the planar antenna and the heat generating element. In the following description of the heat conduction structure, the antenna substrate is illustrated as a single substrate, and wiring around the phase transition switch V and the heat generating element H is omitted. The following example is an example of a heat conduction structure included in the planar antenna and does not limit the heat conduction structure in the present example embodiment.

FIG. 14 is a conceptual diagram illustrating an example of the heat conduction structure included in the planar antenna in the present disclosure. FIG. 14 illustrates a cross-sectional view of the planar antenna. A heat conductive layer 25 is disposed on a lower surface of the antenna substrate 21. The heat conductive layer 25 has a similar configuration to that of the heat conductive layer 15 of the first example embodiment. The phase transition switch V is disposed on a lower surface of the heat conductive layer 25. The heat generating element H disposed on the upper surface of the temperature control substrate 23 is disposed at a position deviated from below the phase transition switch V. The heat generating element H may be formed on the lower surface of the heat conductive layer 25. The heat conductive layer 25 is interposed between the phase transition switch V and the heat generating element H. The heat generating element H is thermally connected to the phase transition switch V via the heat conductive layer 25. In the heat conduction structure of FIG. 14, heat generated from the heat generating element H is conducted to the phase transition switch V via the heat conductive layer 25. That is, in the heat conduction structure of FIG. 14, the heat generated from the heat generating element H is conducted to the phase transition switch V by heat conduction through the heat conductive layer 25.

### (Phase Shifter)

Next, an example of a phase shifter extending structure included in the planar antenna in the present example embodiment will be described with reference to the drawings. In the extending structure, a phase transition line is shared among a plurality of adjacent heat conductive layers. The line length of the phase transition line is controlled by temperature control of the heat generating element H for each heat conductive layer.

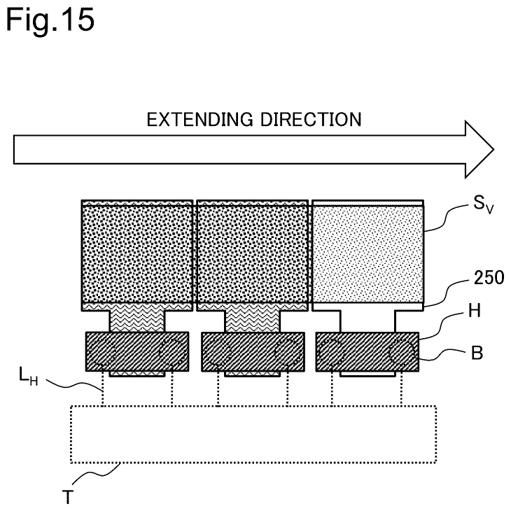

FIG. 15 is a conceptual diagram illustrating an example of an extending structure of a phase shifter included in the planar antenna in the present disclosure. FIG. 15 is a plan view of a portion (phase shift wiring) of the phase shifter viewed from an upper viewing seat. FIG. 15 illustrates a part of the phase shift wiring that has the same switching structure as that of FIG. 14 and is capable of extending the line length according to the selection of the heat generating element. For example, the phase shifter is a line length variable phase shifter in which a plurality of phase shift wirings having different line lengths are branched from a main wiring in a side chain form. For example, the phase shift wiring is a stub having an open end. An openable/closable selection switch (not illustrated) is disposed at a contact point between the plurality of phase shift wiring and the main wiring. The phase shift wiring is selected according to opening/closing of a selection switch disposed at a contact point with the main wiring. The selection switch may be configured by a phase transition switch. The line length of the phase shift wiring is set according to the selection control of the heat generating element H. The phase shift wiring includes a phase transition line S_{V} extending along the extending direction. The phase shift wiring includes a plurality of heat conductive layers 250 arrayed along the extending direction. The phase transition line S_{V} is disposed across the plurality of heat conductive layers 250. The phase transition line S_{V} contains a vanadium dioxide that undergoes phase transition from an insulating phase to a metal phase at a phase transition temperature. The heat generating element H is disposed in each of the plurality of heat conductive layers 250. The heat generating element H arranged in each of the plurality of heat conductive layers 250 generates heat according to the selection via the drive circuit T.

When the selection switch disposed at the contact point with the main wiring is selected and transitioned to the ON state, the phase shift line connected to the main wiring via the selection switch transitions to the ON state. When the heat generating element H connected to the phase shift wiring generates heat, the heat is conducted to the phase transition line S_{V} via the heat conductive layer 250 in which the heat generating element H is disposed. When the temperature of the phase transition line S_{V} exceeds the phase transition temperature of the insulating phase-metal phase, the phase transition line S_{V} transitions to the metal phase. The phase transition line S_{V} that has phase transitioned to the metal phase functions as a line of phase shift wiring. In the example of FIG. 15, a state in which the second heat conductor, which is the first from the left, is selected is indicated by hatching. In this case, the line length of the phase shift wiring is extended from the contact point with the main wiring (not illustrated) to the portion of the phase transition line S_{V} thermally connected to the heat conductor second from the left in FIG. 15. When the temperature of the phase transition line S_{V} falls below the phase transition temperature of the insulating phase-metal phase, the phase transition line S_{V} undergoes phase transition to an insulating phase, and the line length of the phase shift wiring becomes short. In addition, when transitioned to the OFF state in which the selection of the selection switch disposed at the contact point with the main wiring is released, the phase shift line connected to the main wiring via the selection switch transitions to the OFF state.

In the configuration illustrated in FIG. 15, the temperature control substrate on which the temperature control line for controlling the temperature of the heat generating element is arranged and the antenna substrate on which the signal line through which the phase-shifted signal propagates is arranged are separated. Therefore, a shield structure for avoiding crosstalk between the temperature control line and the signal line is unnecessary.

As described above, the planar antenna of the present example embodiment includes the antenna substrate and the temperature control substrate. The antenna substrate is provided with at least one patch antenna, a signal line connected with the patch antenna, and a metal-insulator phase transition element provided on the signal line. The plurality of patch antennas P are arrayed in a two-dimensional array shape. For example, the patch antenna and the signal line are connected by electromagnetic coupling. For example, the antenna substrate includes a ground layer in which an opening for electromagnetically coupling the patch antenna and the signal line is formed below the patch antenna. The signal line includes a first signal line and a second signal line. The first signal line is connected to a signal source via a phase shifter related to each of the plurality of patch antennas. The second signal line is extended to below the plurality of patch antennas. The second signal line is configured to couple with the patch antenna by electromagnetic coupling. The metal-insulator phase transition element is disposed between the first signal line and the second signal line. The temperature control substrate includes a thin film transistor circuit, and at least one heat generating element whose temperature is controlled by the thin film transistor circuit is disposed. The antenna substrate and the temperature control substrate are laminated to each other such that heat of the heat generating element can be conducted to the metal-insulator phase transition element. The heat generating element is disposed in such a way as to be in contact with the metal-insulator phase transition element via a bump formed on the surface of the temperature control substrate. An antenna element including one patch antenna, one metal-insulator phase transition element, and one heat generating element constitutes a phased array antenna.

In the planar antenna of the present example embodiment, the antenna substrate and the temperature control substrate can be manufactured by using different manufacturing processes. Therefore, an additional high temperature is not applied to the temperature control substrate after the manufacturing process of the TFT circuit is finished, and the thin film transistor circuit included in the temperature control substrate is not damaged. That is, according to the present example embodiment, a planar antenna on which a metal-insulator phase transition element whose temperature can be controlled using a thin film transistor circuit is mounted can be achieved. In addition, according to the present example embodiment, since the heat generating element is in contact with the metal-insulator phase transition element, diffusion of heat conducted from the heat generating element to the metal-insulator phase transition element is reduced, and energy loss is suppressed.

### Third Example Embodiment

Next, an antenna device according to a third example embodiment will be described with reference to the drawings. An antenna device of the present disclosure includes planar antennas according to the first and second example embodiments. The antenna device of the present disclosure may be provided with the planar antennas according to the first example embodiment and the second example embodiment. The antenna device of the present example embodiment has a configuration in which a signal source, a control circuit, and the like are added to the planar antennas according to the first example embodiment and the second example embodiment. The following configuration is an example and does not limit the configuration of the antenna device of the present disclosure.

### (Configuration)

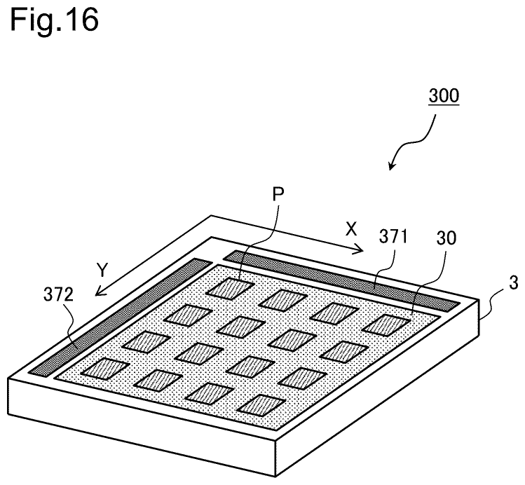

FIG. 16 is a conceptual diagram illustrating an example of a configuration of an antenna device in the present disclosure. FIG. 16 illustrates an example of an external appearance of the antenna device. An antenna device 300 includes a planar antenna 3. The planar antenna 3 includes a planar antenna of the first example embodiment or the second example embodiment. Description on the details of the planar antenna 3 will be omitted. An antenna array 30 including a plurality of patch antennas P arrayed in a two-dimensional array shape is arranged on an upper surface of the planar antenna 3. In the example of FIG. 16, the plurality of patch antennas P are arrayed along the X direction and the Y direction. The plurality of patch antennas P are phased arrayed.

The antenna device 300 is mounted with a first drive circuit 371 and a second drive circuit 372. The first drive circuit 371 and the second drive circuit 372 are circuits used to designate the patch antenna P to be driven. By driving the first drive circuit 371 and the second drive circuit 372, an address associated with each of the patch antennas P can be designated. For example, the first drive circuit 371 and the second drive circuit 372 are formed on the surface of the planar antenna 3. The first drive circuit 371 and the second drive circuit 372 may be formed inside the planar antenna 3.

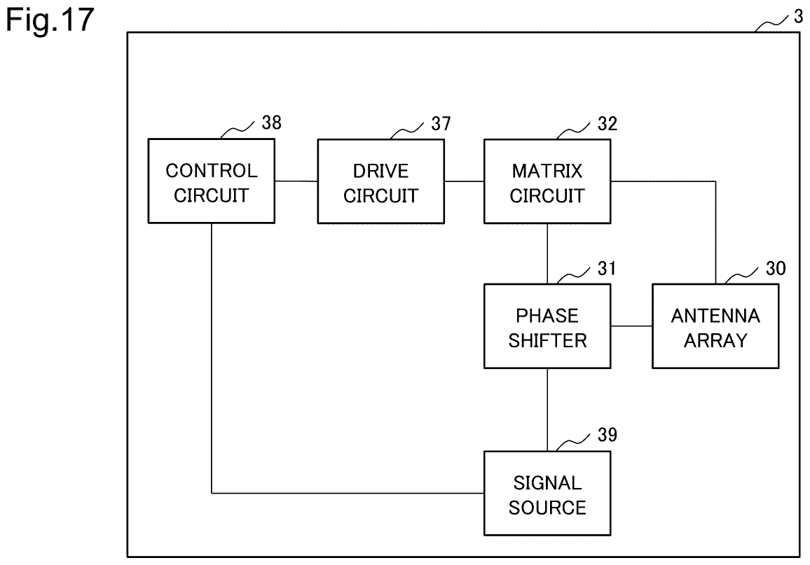

FIG. 17 is a block diagram illustrating an example of a configuration of the antenna device in the present disclosure. The antenna device 300 includes an antenna array 30, a phase shifter 31, a matrix circuit 32, a drive circuit 37, a control circuit 38, and a signal source 39.

The phase shifter 31 is configured for each antenna unit. The phase shifter 31 includes a phase shift wiring, a first signal line, a second signal line, a phase transition switch, a heat generating element, and a temperature control line. The phase shift amount of the phase shifter 31 is set according to the line length of the line formed by the phase shift wiring, the first signal line, the second signal line, and the phase transition switch, and the dielectric constants of the antenna substrate and the temperature control substrate.

The matrix circuit 32 has a configuration in which a plurality of thin film transistors (TFT) are arrayed in a two-dimensional array shape. The matrix circuit 32 is formed using a TFT process technology. For example, a shield layer is formed above the matrix circuit 32. The shield layer is formed to prevent electromagnetic coupling of above and below the shield layer. For example, the shield layer includes an electric conductor. The potential of the shield layer is basically a ground potential. Therefore, a capacitance corresponding to the dielectric constant of the dielectric layer such as the insulating layer or the TFT substrate is formed between the signal line included in the phase shifter 31 and the shield layer. Each of the plurality of TFTs included in the matrix circuit 32 is associated with one of the plurality of patch antennas P included in the antenna array 30. For example, the TFT includes a semiconductor layer such as amorphous silicon or polysilicon.

The drive circuit 37 includes the first drive circuit 371 and the second drive circuit 372. The first drive circuit 371 is a circuit for performing addressing in the X direction. The first drive circuit 371 is connected to a plurality of lines extending in the Y direction. The second drive circuit 372 is a circuit for performing addressing in the Y direction. The second drive circuit 372 is connected to a plurality of lines extending in the X direction. The drive circuit 37 can designate an address associated with each patch antenna P by controlling the first drive circuit 371 and the second drive circuit 372. The drive circuit 37 drives the plurality of TFTs included in the matrix circuit 32 under the control of the control circuit 38. The drive circuit 37 individually drives the plurality of TFTs arrayed in a two-dimensional array shape.

The control circuit 38 drives the drive circuit 37 according to a control signal from the outside. The control circuit 38 drives the drive circuit 37 by an active matrix driving method. In addition, the control circuit 38 outputs a control signal from the outside to the signal source 39. For example, the control circuit 38 is achieved by a microcomputer or a microcontroller. For example, the control circuit 38 includes a central processing unit (CPU), a random access memory (RAM), a read only memory (ROM), a flash memory, and the like. The control circuit 38 executes control according to a program stored in advance. The control circuit 38 executes control corresponding to a program according to a preset schedule or timing, an external control instruction, or the like. For example, the control circuit 38 controls the antenna array 30 including the plurality of patch antennas P included in the planar antenna 3 to transmit a radio wave having directivity from the antenna array 30. As described above, the antenna array 30 is used as a phased array antenna.

The signal source 39 is connected to a switch group including a plurality of phase transition switches included in a plurality of antenna elements included in the phase shifter 31. In addition, the signal source 39 is connected to the control circuit 38. The signal source 39 acquires a control signal from the control circuit 38. The signal source 39 controls ON/OFF of the plurality of phase transition switches constituting the switch group according to the control signal. The signal source 39 may be configured to directly receive a control signal from the outside without passing through the control circuit 38.

The signal reaching a signal input unit of the phase shifter 31 through the signal line (not illustrated) connected to the TFT in the ON state is phase-shifted by the line length set in the phase shifter 31 and the phase shift amount corresponding to the dielectric constants of the dielectrics of the antenna substrate and the temperature control substrate. The phase-shifted signal propagates from the second signal line to the patch antenna P by electromagnetic coupling. The signal propagated to the patch antenna P is transmitted from the patch antenna P as a transmission target radio wave. The radio wave transmitted from the patch antenna P is based on a signal output from a transmission circuit (not illustrated). The information included in the signal is not particularly limited.

Furthermore, the radio wave received by the patch antenna P is received according to the capacitance based on the dielectric constant of the antenna substrate interposed between the patch antenna P and the second signal line. The phase of the received radio wave is shifted by the line length set in the phase shifter 31 and the phase shift amount corresponding to the dielectric constants of the antenna substrate and the temperature control substrate. The phase-shifted signal is received by a reception circuit (not illustrated) through a signal line. Information included in the signal received by the reception circuit is decoded by a decoder (not illustrated).

As described above, the antenna device of the present example embodiment includes the planar antenna according to the first example embodiment or the second example embodiment, the signal source, the phase shifter, the matrix circuit, the drive circuit, and the control circuit. The signal source is connected to a metal-insulator phase transition element included in the planar antenna via a signal line. The phase shifter includes a phase shift wiring disposed between the metal-insulator phase transition element and the signal source. In the matrix circuit, a plurality of thin film transistors connected to wirings included in a planar antenna are arrayed in a two-dimensional array shape. The drive circuit drives the thin film transistors included in the matrix circuit. The control circuit drives the drive circuit according to a control signal. An antenna device of one aspect includes a planar antenna according to the first example embodiment or the second example embodiment. Therefore, according to the present aspect, an antenna device on which the metal-insulator phase transition element whose temperature can be controlled using the thin film transistor circuit is mounted can be provided.

In one aspect of the present example embodiment, the control circuit controls the plurality of patch antennas included in the planar antenna to transmit a radio wave having directivity from the antenna array including the plurality of patch antennas. According to the present aspect, an antenna array including the plurality of patch antennas can be used as a phased array antenna.

### Fourth Example Embodiment

First, a planar antenna according to a fourth example embodiment will be described with reference to the drawings. The planar antenna of the present example embodiment has a configuration obtained by simplifying the planar antennas of the first and second example embodiments. For example, the functions of the components included in the planar antenna in the present example embodiment are achieved by the functions of the components included in the planar antennas in the first and second example embodiments. For example, the planar antenna in the present example embodiment is controlled by a control system included in the antenna device in the third example embodiment.

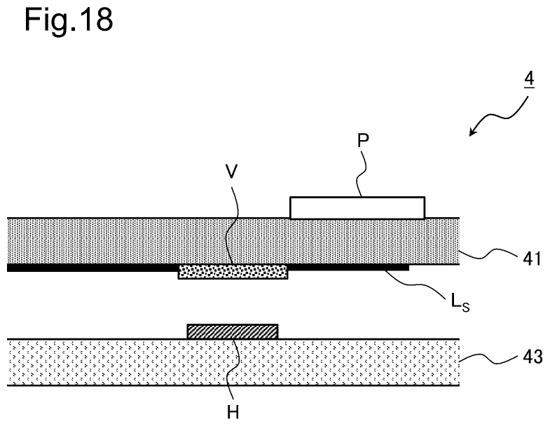

FIG. 18 is a conceptual diagram illustrating an example of a configuration of the planar antenna in the present disclosure. The planar antenna 4 includes an antenna substrate 41 and a temperature control substrate 43. At least one patch antenna P, a signal line L_{S} connected to the patch antenna P, and a phase transition element V (metal-insulator phase transition element) provided on the signal line L_{S} are arranged on the antenna substrate 41. The temperature control substrate 43 includes a thin film transistor circuit, and at least one heat generating element H whose temperature is controlled by the thin film transistor circuit is disposed. The antenna substrate and the temperature control substrate are laminated to each other such that heat of the heat generating element H can be conducted to the phase transition element V (metal-insulator phase transition element).

In the planar antenna of the present example embodiment, the antenna substrate and the temperature control substrate can be manufactured by using different manufacturing processes. Therefore, an additional high temperature is not applied to the temperature control substrate after the manufacturing process of the TFT circuit is finished, and the thin film transistor circuit included in the temperature control substrate is not damaged. That is, according to the present example embodiment, a planar antenna on which a metal-insulator phase transition element whose temperature can be controlled using a thin film transistor circuit is mounted can be achieved.

### (Hardware)

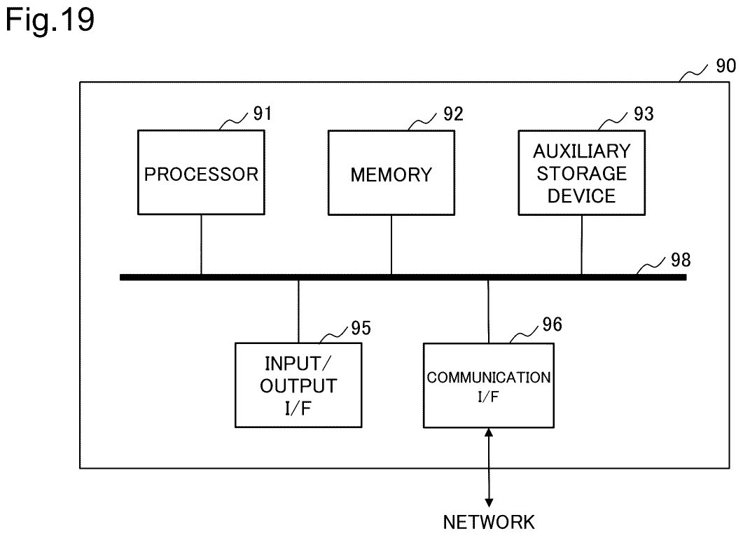

As illustrated in FIG. 19, an information processing device 90 includes a processor 91, a memory 92, an auxiliary storage device 93, an input/output interface 95, and a communication interface 96. In FIG. 19, the interface is abbreviated as an interface (I/F). The information processing device 90 may include a plurality of at least one of the processor 91, the memory 92, the auxiliary storage device 93, the input/output interface 95, and the communication interface 96. The processor 91, the memory 92, the auxiliary storage device 93, the input/output interface 95, and the communication interface 96 are data-communicably connected to each other via a bus 98. In addition, the processor 91, the memory 92, the auxiliary storage device 93, and the input/output interface 95 are connected to a network such as the Internet or an intranet via the communication interface 96.

The processor 91 develops a program (command) stored in the auxiliary storage device 93 or the like in the memory 92. For example, the program is a software program for executing the control in the present disclosure. The processor 91 executes the program developed in the memory 92. The processor 91 executes the control in the present disclosure by executing the program. The processor 91 may be configured by a single piece of hardware or may be configured by a plurality of pieces of hardware.

The memory 92 is a storage device having an area in which a program is developed. A program stored in the auxiliary storage device 93 or the like is developed in the memory 92 by the processor 91. The memory 92 is achieved by, for example, a volatile memory such as a dynamic random access memory (DRAM). Furthermore, a nonvolatile memory such as a magnetoresistive random access memory (MRAM) may be applied as the memory 92. The memory 92 may be configured by a single piece of hardware or may be configured by a plurality of pieces of hardware.

The auxiliary storage device 93 stores various data such as programs. For example, the auxiliary storage device 93 is achieved by a hard disk or a local disk such as a flash memory. The auxiliary storage device 93 may be configured by a single piece of hardware or may be configured by a plurality of pieces of hardware. The auxiliary storage device 93 may be configured as external hardware. In addition, various data may be stored in the memory 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a standard or a specification. The input/output interface 95 may be configured by a single piece of hardware or may be configured by a plurality of pieces of hardware. The input/output interface 95 and the communication interface 96 may be shared as an interface connected to an external device.

Input devices such as a keyboard, a mouse, and a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 includes a display control device (not illustrated) for controlling display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via the input/output interface 95.

The above is an example of a hardware configuration for enabling control in the present disclosure. The hardware configuration of FIG. 19 is an example of a hardware configuration for executing control in the present disclosure, and does not limit the scope of the present disclosure. A program for causing a computer to execute the control in the present disclosure is also included in the scope of the present disclosure.

A program recording medium in which a program for executing processes in the present example embodiment is recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. Furthermore, the recording medium may be achieved by a magnetic recording medium such as a flexible disk, or other recording media.

The components in the present disclosure may be combined in any manner. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all of the above-described example embodiments may be described as the following supplementary notes, but are not limited to the following supplementary notes.

### (Supplementary Note 1)

A planar antenna including:
an antenna substrate on which at least one patch antenna, a signal line connected to the patch antenna, and a metal-insulator phase transition element provided on the signal line are arranged, and
a temperature control substrate including a thin film transistor circuit and in which at least one heat generating element whose temperature is controlled by the thin film transistor circuit is disposed, wherein
the antenna substrate and the temperature control substrate are laminated such that heat of the heat generating element is conductable to the metal-insulator phase transition element.

### (Supplementary Note 2)

The planar antenna according to Supplementary Note 1, wherein
the metal-insulator phase transition element includes
a phase transition switch containing a vanadium dioxide, and
the heat generating element is configured to generate heat to a temperature exceeding a phase transition temperature at which the vanadium dioxide undergoes a phase transition from an insulating phase to a metal phase according to the temperature control of the thin film transistor circuit.

### (Supplementary Note 3)

The planar antenna according to Supplementary Note 1, wherein
a plurality of the patch antennas are arrayed in a two-dimensional array shape,
the signal line includes
a first signal line connected to a signal source via a phase shifter associated with each of the plurality of patch antennas, and
a second signal line extending to below the plurality of patch antennas,
the second signal line is configured to connect with the patch antenna by electromagnetic coupling,
the metal-insulator phase transition element is configured to be disposed between the first signal line and the second signal line, and
an antenna element including one of each of the patch antenna, the metal-insulator phase transition element, and the heat generating element constitutes a phased array antenna.

### (Supplementary Note 4)

The planar antenna according to Supplementary Note 3, further comprising
a spacer disposed between the antenna substrate and the temperature control substrate in such a way as to surround the metal-insulator phase transition element and the heat generating element.

### (Supplementary Note 5)

The planar antenna according to Supplementary Note 3, further comprising
a heat conductive sheet is disposed between the metal-insulator phase transition element and the heat generating element.

### (Supplementary Note 6)

The planar antenna according to Supplementary Note 5, further comprising
a heat conductive layer formed between the antenna substrate and the metal-insulator phase transition element, wherein
the metal-insulator phase transition element and the heat generating element are disposed in a positional relationship of not overlapping each other in a plan view, and
a heat conductor is disposed between the heat generating element and the heat conductive layer.

### (Supplementary Note 7)

The planar antenna according to Supplementary Note 3, wherein
the heat generating element is configured to be
formed on a surface of the metal-insulator phase transition element, and
disposed to be connected to wiring constituting the thin-film transistor circuit via a bump formed on a surface of the temperature control substrate.

### (Supplementary Note 8)

The planar antenna according to Supplementary Note 1, wherein
the patch antenna and the signal line are connected by electromagnetic coupling.

### (Supplementary Note 9)

The planar antenna according to Supplementary Note 8, wherein
the antenna substrate includes a ground layer in which an opening for electromagnetic coupling between the patch antenna and the signal line is formed below the patch antenna.

### (Supplementary Note 10)

An antenna device including
the planar antenna according to any one of Supplementary Notes 1 to 9,
a signal source connected to a metal-insulator phase transition element included in the planar antenna via a signal line,
a phase shifter including a phase shift wiring disposed between the metal-insulator phase transition element and the signal source,
a matrix circuit in which a plurality of thin film transistors connected to wirings included in the planar antenna are arrayed in a two-dimensional array shape,
a drive circuit for driving the thin film transistor included in the matrix circuit, and
a control circuit for driving the drive circuit according to a control signal.

1. A planar antenna comprising:
an antenna substrate on which at least one patch antenna, a signal line connected to the patch antenna, and a metal-insulator phase transition element provided on the signal line are arranged; and
a temperature control substrate including a thin film transistor circuit and in which at least one heat generating element whose temperature is controlled by the thin film transistor circuit is disposed, wherein
the antenna substrate and the temperature control substrate are laminated such that heat of the heat generating element is conductable to the metal-insulator phase transition element.

2. The planar antenna according to claim 1, wherein
the metal-insulator phase transition element includes
a phase transition switch containing a vanadium dioxide, and
the heat generating element is configured to generate heat to a temperature exceeding a phase transition temperature at which the vanadium dioxide undergoes a phase transition from an insulating phase to a metal phase according to the temperature control of the thin film transistor circuit.

3. The planar antenna according to claim 1, wherein
a plurality of the patch antennas are arrayed in a two-dimensional array shape,
the signal line includes
a first signal line connected to a signal source via a phase shifter associated with each of the plurality of patch antennas, and
a second signal line extending to below the plurality of patch antennas,
the second signal line is configured to connect with the patch antenna by electromagnetic coupling,
the metal-insulator phase transition element is configured to be disposed between the first signal line and the second signal line, and
an antenna element including one of each of the patch antenna, the metal-insulator phase transition element, and the heat generating element constitutes a phased array antenna.

4. The planar antenna according to claim 3, further comprising
a spacer disposed between the antenna substrate and the temperature control substrate in such a way as to surround the metal-insulator phase transition element and the heat generating element.

5. The planar antenna according to claim 3, further comprising
a heat conductive sheet disposed between the metal-insulator phase transition element and the heat generating element.

6. The planar antenna according to claim 5, further comprising
a heat conductive layer formed between the antenna substrate and the metal-insulator phase transition element, wherein
the metal-insulator phase transition element and the heat generating element are disposed in a positional relationship of not overlapping each other in a plan view, and
a heat conductor is disposed between the heat generating element and the heat conductive layer.

7. The planar antenna according to claim 3, wherein
the heat generating element is configured to be
formed on a surface of the metal-insulator phase transition element, and
disposed to be connected to wiring constituting the thin-film transistor circuit via a bump formed on a surface of the temperature control substrate.

8. The planar antenna according to claim 1, wherein
the patch antenna and the signal line are connected by electromagnetic coupling.

9. The planar antenna according to claim 8, wherein
the antenna substrate includes a ground layer in which an opening for electromagnetic coupling between the patch antenna and the signal line is formed below the patch antenna.

10. An antenna device including:
the planar antenna according to claim 1;
a signal source connected to a metal-insulator phase transition element included in the planar antenna via a signal line;
a phase shifter including a phase shift wiring disposed between the metal-insulator phase transition element and the signal source;
a matrix circuit in which a plurality of thin film transistors connected to wirings included in the planar antenna are arrayed in a two-dimensional array shape;
a drive circuit for driving the thin film transistor included in the matrix circuit; and
a control circuit for driving the drive circuit according to a control signal.
